(19) United States
(12) Patent Application Publication
(10) Pub. No.: US 2012/0069215 A1
(43) Pub. Date: Mar. 22, 2012

(54) METHOD AND APPARATUS FOR GENERATING ADDITIONAL INFORMATION OF IMAGE

(75) Inventors: Jeong-Hun Park, Yongin-si (KR); Sung-Sik Park, Seoul (KR); Young-Joon Ahn, Yongin-si (KR); Soo-In Jang, Seoul (KR)

(73) Assignee: SAMSUNG ELECTRONICS CO., LTD., Suwon-si (KR)

(21) Appl. No.: 13/235,244

(22) Filed: Sep. 16, 2011

(30) Foreign Application Priority Data
Sep. 17, 2010 (KR) 10-2010-0091958

(51) Int. Cl. H04N 5/76

(52) U.S. Cl. 348/231.3; 348/E05.031

(57) ABSTRACT

A method of generating additional information of an image. The method includes designating a first image and providing an interface for displaying at least one second image having position information. The method also includes setting position information of a selected second image as position information of the first image.

### CROSS-REFERENCE TO RELATED APPLICATION(S) AND CLAIM OF PRIORITY

The present application is related to and claims the benefit of Korean Patent Application No. 10-2010-0091958, filed on Sep. 17, 2010, in the Korean Intellectual Property Office, the disclosure of which is incorporated herein in its entirety by reference.

### TECHNICAL FIELD OF THE INVENTION

The present invention generally relates to a method and apparatus for generating additional information of an image, and more particularly, to a method and apparatus for generating additional information of an image, by which position information of an image that does not currently possess position information is set by referring to an image that includes position information.

### BACKGROUND OF THE INVENTION

When individuals possess a digital video capturing device, such as a digital camera or a digital camcorder, or the like, they are likely to generate a plurality of captured digital images. Accordingly, a method of managing or sharing the generated images is significant, and a method of recording a position to capture images and marking the position on a map is also an important image managing method.

In the case of a smartphone equipped with a Global Positioning System (GPS) reception device, when a digital image is captured, position information is automatically recorded on the image, and some of the newly released digital cameras and digital camcorders support GEO TAGGING with a built-in GPS reception device.

However, many of a large number of already released cameras or digital image generating devices owned by individuals may not have position information functions yet, and in order to mark position information on a map, an individual may need to directly assign a position on a digital map using a Personal Computer (PC) or the like.

### SUMMARY OF THE INVENTION

To address the above-discussed deficiencies of the prior art, it is a primary object to provide a method and apparatus for generating additional information of an image, by which position information of an image that does not currently possess position information can be automatically set or easily input by reducing setting steps on the basis of position information of another image having its position information.

According to an aspect of the present invention, there is provided a method of generating additional information of an image. The method includes designating a first image and providing an interface for displaying at least one second image having position information. The method also includes setting position information of a selected second image as position information of the first image.

The first image and the second image may include time information, and the providing of the interface may include providing the interface for displaying the second image if a difference between the time information of the second image and the time information of the first image is equal to or less than a predetermined threshold.

The time information and the position information may be included in metadata of the first image and the second image.

According to another aspect of the present invention, there is provided a method of generating additional information of an image. The method includes specifying at least one object included in a first image. The method also includes searching for and finding at least one second image including the specified object and position information. The method further includes setting the position information of the at least one found second image as position information of the first image.

The specifying of the object may include, if the object is a human being, recognizing a face of at least one human being included in the first image, and specifying the human being according to the recognized face.

The first image and the second image may include time information, and the search for the second image may include searching for the second image for which a difference between the time information of the second image and the time information of the first image is equal to or less than a predetermined threshold from among the at least one second image including the specified object and position information.

The setting of the position information of the found second image as the position information of the first image may include, if the number of found second images is more than one, grouping the found second images, and setting position information of the group as the position information of the first image.

The setting of the position information of the found second image as the position information of the first image may include providing an interface for displaying the found second image, and setting position information of a selected second image as the position information of the first image.

According to another aspect of the present invention, there is provided a method of generating additional information of an image. The method includes specifying at least one object included in a first image and setting a predetermined time period. The method also includes searching for at least one second image including the specified object, position information, and time information corresponding to the time period. The method further includes setting the position information of the found second image as position information of the first image.

According to another aspect of the present invention, there is provided a method of generating additional information of an image. The method includes searching for and finding images having the same unique identification of an image generating device, which is included in the images. The method also includes selecting images including time information corresponding to a predetermined time period from among the found images. The method further includes setting position information of images, which do not have position information, with position information of images that have position information among the selected images.

According to another aspect of the present invention, there is provided an apparatus for generating additional information of an image. The apparatus includes an interface unit configured to designate a first image and display at least one second image having position information. The apparatus also includes a controller configured to set position information of a selected second image as position information of the first image based on a user's selection.

According to another aspect of the present invention, there is provided an apparatus for generating additional information of an image. The apparatus includes a storage unit configured to store images. The apparatus also includes a controller configured to specify at least one object included in a first image among the stored images, search for and find at least one second image including the specified object and position information, and set the position information of the found second image as position information of the first image.

According to another aspect of the present invention, there is provided an apparatus for generating additional information of an image. The apparatus includes an interface unit configured to specify at least one object included in a first image and set a predetermined time period. The apparatus also includes a controller configured to search for and find at least one second image including the specified object, position information, and time information corresponding to the time period and set the position information of the found second image as position information of the first image.

According to another aspect of the present invention, there is provided an apparatus for generating additional information of an image. The apparatus includes a storage unit configured to store images. The apparatus also includes a controller configured to search for images having the same unique identification of an image generating device from among the stored images, select images including time information corresponding to a predetermined time period from among the found images, and set position information of images, which do not have position information, with position information of images that have position information among the selected images.

Before undertaking the DETAILED DESCRIPTION OF THE INVENTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 is a flowchart of a method of generating additional information of an image according to an embodiment of the present invention;

FIG. 2 illustrates a scenario according to the method of FIG. 1;

FIG. 3 is a flowchart of a method of generating additional information of an image, according to another embodiment of the present invention;

FIGS. 4 and 5 illustrate a scenario according to the method of FIG. 3;

FIG. 6 is a flowchart of a method of generating additional information of an image, according to another embodiment of the present invention;

FIG. 7 illustrates a scenario according to the method of FIG. 6;

FIG. 8 is a flowchart of a method of generating additional information of an image, according to another embodiment of the present invention;

FIG. 9 illustrates scenarios according to the method of FIG. 8; and

FIG. 10 is a block diagram of an apparatus for generating additional information of an image, according to an embodiment of the present invention.

### DETAILED DESCRIPTION OF THE INVENTION

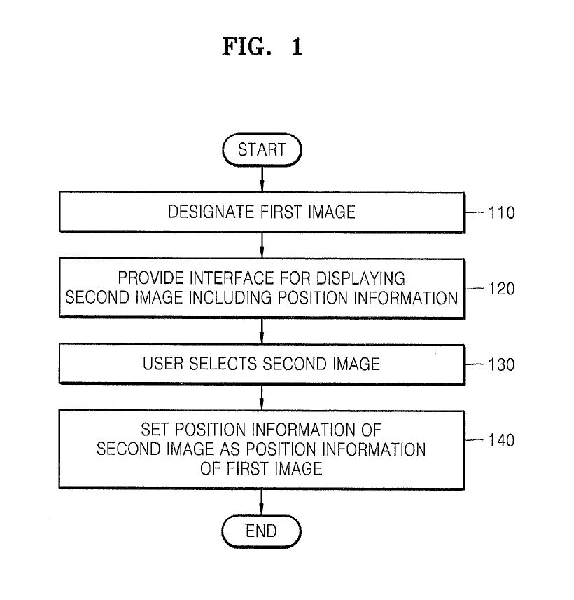

FIGS. 1 through 10, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged wireless device.

FIG. 1 is a flowchart of a method of generating additional information of an image according to an embodiment of the present invention.

Referring to FIG. 1, in operation 110, if a user selects a first image, an image additional information generating apparatus selects the first image. The first image includes time information, such as an image generation time, and does not include position information, such as Global Positioning System (GPS) information.

In operation 120, the image additional information generating apparatus provides an interface for displaying a second image. The second image includes time information and position information. The image additional information generating apparatus provides a second image that includes time information similar to the time information of the first image. In detail, the image additional information generating apparatus compares the time information of the second image with the time information of the first image and provides a second image for which a difference between the time information of the second image and the time information of the first image is equal to or less than a predetermined threshold. For example, the image additional information generating apparatus provides a second image that includes time information corresponding to a time period between one hour prior to the time information of the first image and one hour after the time information of the first image. If the number of second images is plural, the additional information generating apparatus may provide a second image that includes time information nearest to the time information of the first image. The time information and position information of the second image may be displayed on the interface.

Here, the time information and the position information of the first image and the second image may be included in metadata of an image file.

In operation 130, the user selects a second image from the provided interface. The user may select a second image according to the time information and the position information of the second image displayed on the provided interface.

In operation 140, the image additional information generating apparatus sets the position information of the selected second image as position information of the selected first image. That is, the image additional information generating apparatus may set the position information of the second image as the position information of the first image in the metadata of the first image.

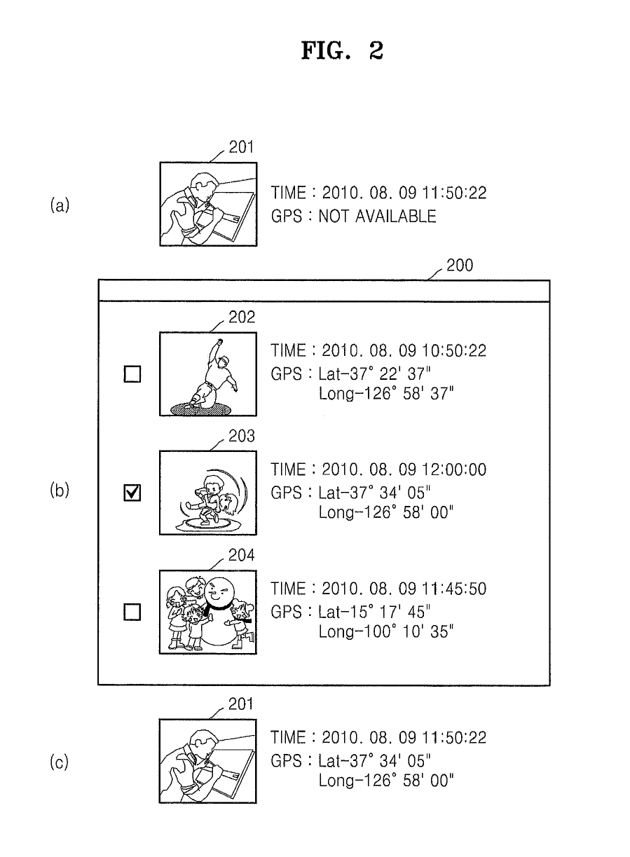

FIG. 2 illustrates a scenario according to the method of FIG. 1.

Referring to FIG. 2, the user selects a first image 201 in FIG. 2(a). The first image 201 includes time information but does not include position information. Thereafter, in FIG. 2(b), the image additional information generating apparatus provides an interface 200 for displaying a second image 202, a third image 203, and a fourth image 204, each including position information and time information approximate to the time information of the first image. The user or a provider of the image additional information generating apparatus can set proximity to time information. The user selects the third image 203. Thereafter, in FIG. 2(c), the image additional information generating apparatus sets position information of the first image according to position information of the third image 203. Accordingly, the position information of the first image is set, wherein the position information of the first image is identical to the position information of the third image 203.

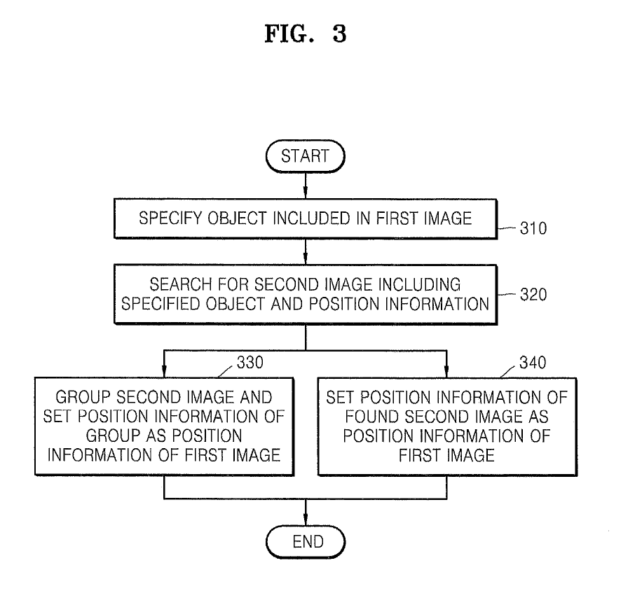

FIG. 3 is a flowchart of a method of generating additional information of an image, according to another embodiment of the present invention.

Referring to FIG. 3, in operation 310, an image additional information generating apparatus specifies an object included in a first image. If the object is a human being, the image additional information generating apparatus recognizes a face of at least one human being included in the first image and specifies the human being according to the recognized face. In another embodiment, information regarding a human being specified through face recognition may be previously stored in the image additional information generating apparatus. The method of recognizing a face conforms to a common face recognition method but is not limited thereto. For example, provided that two people are displayed in the first image, the image additional information generating apparatus may specify one person as an object A and the other as object B. The first image includes time information, such as an image generation time, but does not include position information, such as GPS information.

In operation 320, the image additional information generating apparatus searches for a second image including the specified object and position information. The second image may also include time information. The image additional information generating apparatus compares the time information of the second image with the time information of the first image and searches for a second image for which a difference between the time information of the second image and the time information of the first image is equal to or less than a predetermined threshold. For example, the image additional information generating apparatus searches for a second image that includes time information corresponding to a time period between one hour prior to the time information of the first image and one hour after the time information of the first image, the same object, and position information. The image additional information generating apparatus may search for images stored in a storage unit thereof or images shared in a network.

In operation 330, if the number of second images is plural, the image additional information generating apparatus groups the second images. Thereafter, the image additional information generating apparatus sets position information of the group according to the second images and sets the position information of the group as position information of the first image.

In operation 340, the image additional information generating apparatus sets the position information of the found second image as position information of the first image. If the number of found second images is plural, the image additional information generating apparatus may set position information of a second image that includes time information most approximate to the time information of the first image as position information of the first image. If the number of found second images is plural, the process may proceed to operation 330 or 340, and this can be set by a user of a provider of the image additional information generating apparatus.

In another embodiment, the image additional information generating apparatus may provide an interface for displaying found second images to the user, and when the user selects any one of the found second images, the image additional information generating apparatus may set position information of the selected second image as position information of the first image.

If information regarding people displayed in images is the same and the captured times in the time information are similar to each other, the possibility that the images are captured in the same position is very high, so if the method of FIG. 3 is used, position information of an image without its position information may be easily set.

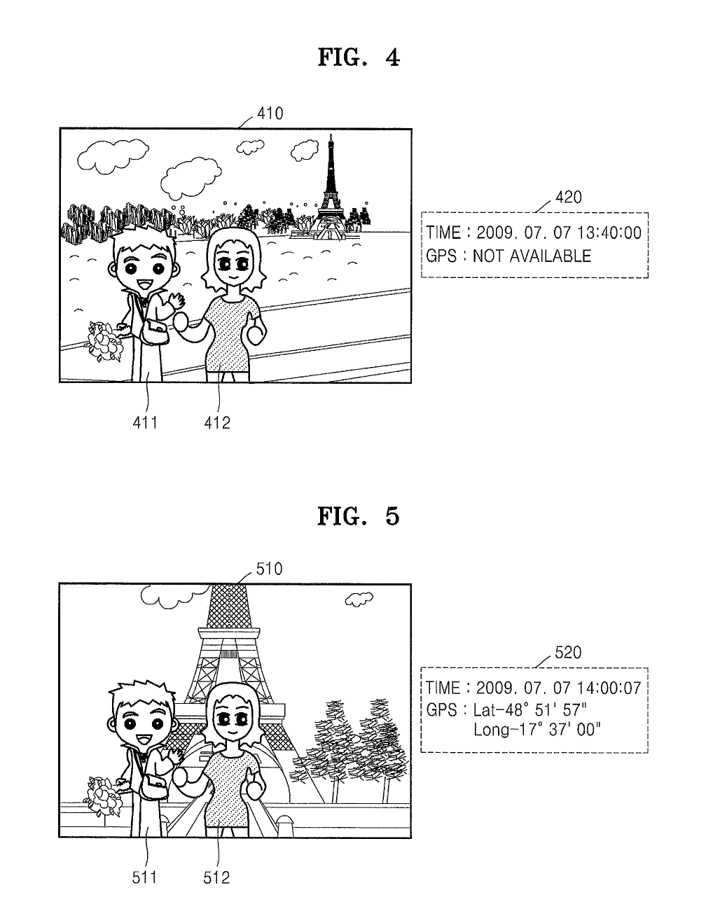

FIGS. 4 and 5 illustrate a scenario according to the method of FIG. 3.

Referring to FIG. 4, a first image 410 includes additional information 420 containing time information (2009. 07. 07 13:40:07). In addition, two objects 411 and 412 are displayed in the first image 410. An image additional information generating apparatus specifies the two objects 411 and 412 through face recognition. Thereafter, the image additional information generating apparatus searches for a second image that includes the two specified objects 411 and 412, position information, and time information similar to that of the first image 410. The found second image 510 is shown in FIG. 5. Referring to FIG. 5, the second image 510 includes additional information 520 containing two objects 511 and 512 identical to the two objects 411 and 412 specified in FIG. 4, time information (2009. 07. 07. 14:00:07), and position information (Lat-48° 51′57″ and Long-17° 37′00″). The image additional information generating apparatus sets the position information (Lat-48° 51′57″ and Long-17° 37′00″) of the additional information 520 as position information of the first image 410.

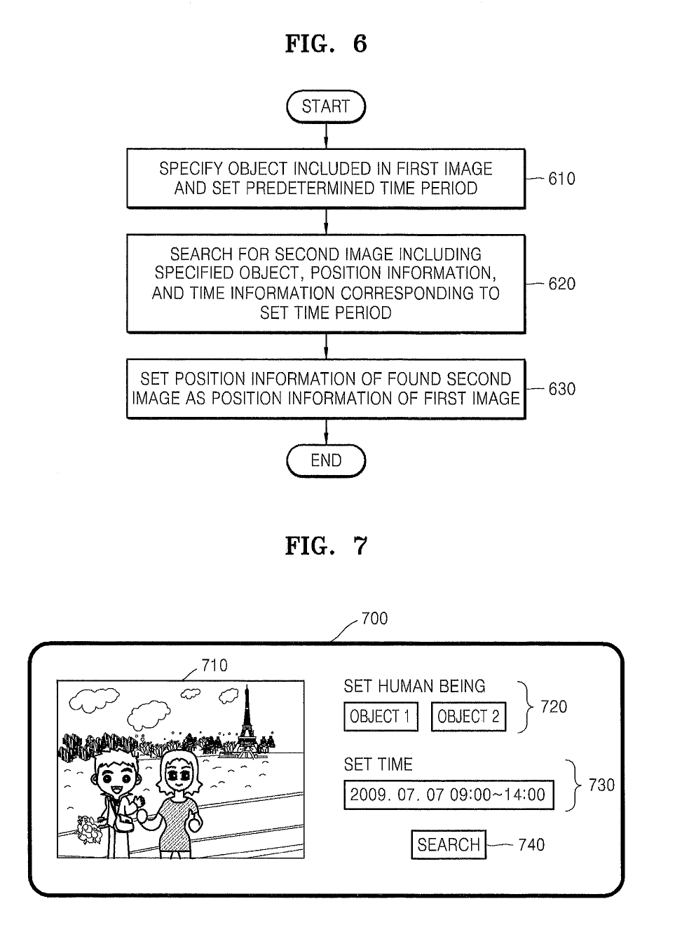

FIG. 6 is a flowchart of a method of generating additional information of an image, according to another embodiment of the present invention.

Referring to FIG. 6, in operation 610, an image additional information generating apparatus specifies an object included in a first image and sets a predetermined time period. If the object is a human being, the image additional information generating apparatus recognizes a face of at least one human being included in the first image and specifies the human being according to the recognized face. In addition, the image additional information generating apparatus sets a time period for filtering a second image according to time information included in the second image.

FIG. 7 illustrates a scenario according to the method of FIG. 6. Referring to FIG. 7, to set position information of a first image 710, an interface including a specified object 720, a time period 730 to be set, and a search button 740 is shown.

In operation 620, the image additional information generating apparatus searches for a second image including the specified object, position information, and time information corresponding to the set time period. The image additional information generating apparatus may search for images stored in a storage unit thereof or images shared in a network.

In operation 630, the image additional information generating apparatus sets the position information of the found second image as position information of the first image. The image additional information generating apparatus may provide an interface for displaying the found second image to the user, wherein the user can set the position information of the found second image as position information of the first image.

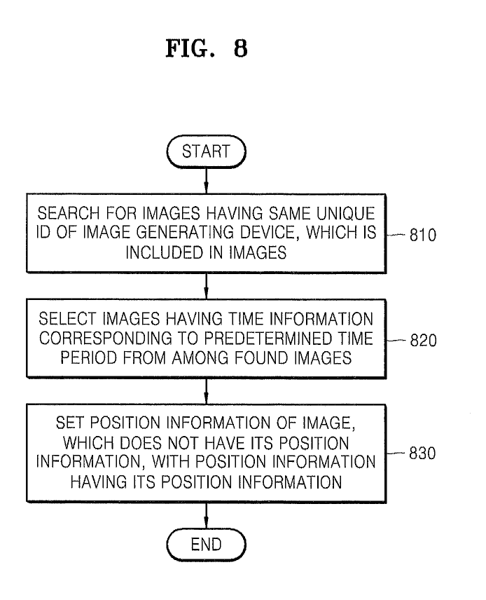

FIG. 8 is a flowchart of a method of generating additional information of an image, according to another embodiment of the present invention.

Referring to FIG. 8, in operation 810, an image additional information generating apparatus searches for images having the same unique identification (ID) of an image generating device. The image additional information generating apparatus may search for images stored in a storage unit thereof or images shared in a network.

In operation 820, the image additional information generating apparatus selects images including time information corresponding to a predetermined time period from among the found images. The predetermined time period can be set by a user or a provider of the image additional information generating apparatus.

In operation 830, the image additional information generating apparatus sets position information of an image that does not currently possess position information with position information of an image that includes its position information among the selected images.

If images have the same camera ID, continuous time information, and position information, it can be determined that the corresponding camera is a camera equipped with a GPS reception device, and, if an image without its position information exists, it is determined that the image was captured when there is a temporary GPS trouble or captured indoors where there is no GPS reception, and position information of the image may be set as described above.

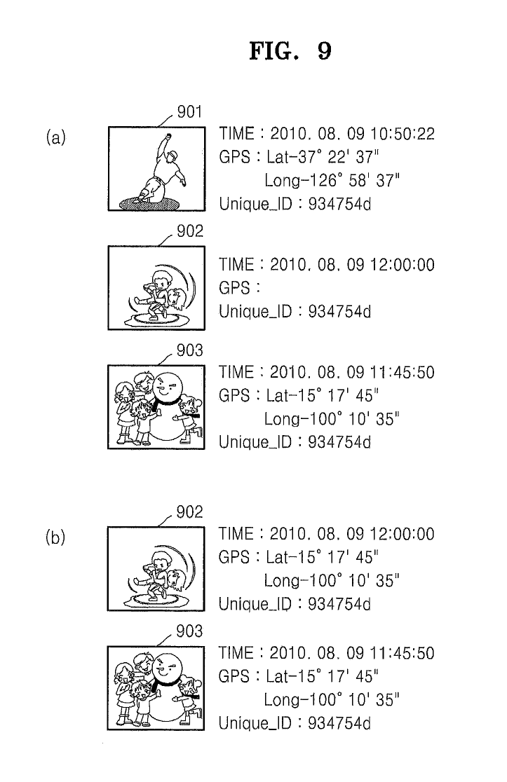

FIG. 9 illustrates scenarios according to the method of FIG. 8.

Referring to FIG. 9, in FIG. 9(a), an image additional information generating apparatus searches for images having the same unique ID of an image generating device. Images 901, 902, and 903 having a unique ID of 934754d are shown. In FIG. 9(b), the image additional information generating apparatus sets a time period and selects the images 902 and 903 corresponding to the set time period from among the found images 901, 902, and 903. The image 902 does not include its position information, and the image 903 includes its position information. In this situation, the image additional information generating apparatus sets GPS information of the image 903, the position information of the image 903, as position information of the image 902.

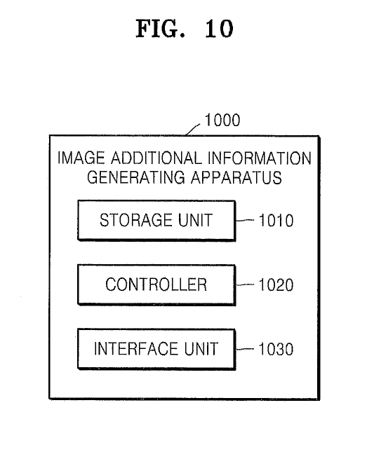

FIG. 10 is a block diagram of an apparatus 1000 for generating additional information of an image, according to an embodiment of the present invention.

Referring to FIG. 10, the apparatus 1000 includes a storage unit 1010, a controller 1020, and an interface unit 1030.

In an embodiment, if a user selects a first image stored in the storage unit 1010, the interface unit 1030 selects the first image and provides an interface for displaying a second image. The first image includes time information, such as an image generation time, but does not include position information, such as GPS information. The second image includes time information and position information. The interface unit 1030 provides a second image that includes time information similar to the time information of the first image. In detail, the interface unit 1030 compares the time information of the second image with the time information of the first image and provides a second image for which a difference between the time information of the second image and the time information of the first image is equal to or less than a predetermined threshold. For example, the interface unit 1030 provides a second image that includes time information corresponding to a time period between one hour prior to the time information of the first image and one hour after the time information of the first image. If the number of second images is plural, the interface unit 1030 may provide a second image that includes time information nearest to the time information of the first image first. The time information and position information of the second image may be displayed on the interface. Here, the time information and the position information of the first image and the second image may be included in metadata of an image file. Thereafter, the user selects a second image from the provided interface. The user may select a second image according to the time information and the position information of the second image displayed on the provided interface.

The controller 1020 sets the position information of the selected second image as position information of the first image. That is, the controller 1020 may set the position information of the second image as the position information of the first image in the metadata of the first image.

In another embodiment, the storage unit 1010 stores therein a first image and a second image.

The controller 1020 specifies an object included in the first image. If the object is a human being, the controller 1020 recognizes a face of at least one human being included in the first image and specifies the human being according to the recognized face. In another embodiment, information regarding a human being specified through face recognition may be previously stored in the storage unit 1010. The method of recognizing a face conforms to a common face recognition method but is not limited thereto. The first image includes time information, such as an image generation time, but does not include position information, such as GPS information. Thereafter, the controller 1020 searches for a second image including the specified object and position information. The second image may also include time information. The controller 1020 compares the time information of the second image with the time information of the first image and searches for a second image for which a difference between the time information of the second image and the time information of the first image is equal to or less than a predetermined threshold. For example, the controller 1020 searches for a second image that includes time information corresponding to a time period between one hour prior to the time information of the first image and one hour after the time information of the first image, the same object, and position information. The controller 1020 may search for second images stored in the storage unit 1010 or second images shared in a network. Thereafter, the controller 1020 sets the position information of the found second image as position information of the first image. If the number of found second images is plural, the controller 1020 may set position information of a second image that includes time information most approximate to the time information of the first image as position of the first image.

In addition, if the number of second images is plural, the controller 1020 may group the second images, set position information of the group according to the second images, and set the position information of the group as position information of the first image.

The interface unit 1030 may provide an interface for displaying found second images to a user, and when the user selects any one of the found second images, the controller 1020 may set position information of the selected second image as position information of the first image.

In another embodiment, the interface unit 1030 specifies an object included in a first image and sets a predetermined time period. If the object is a human being, the interface unit 1030 recognizes a face of at least one human being included in the first image and specifies the human being according to the recognized face. In addition, the interface unit 1030 sets a time period for filtering a second image according to time information included in the second image.

The controller 1020 searches for a second image including the specified object, position information, and time information corresponding to the set time period. The controller 1020 may search for images stored in the storage unit 1010 or images shared in a network. The controller 1020 sets the position information of the found second image as position information of the first image. In addition, the interface unit 1030 may provide an interface for displaying the found second image to a user, wherein the user can set the position information of the found second image as position information of the first image.

In yet another embodiment, the controller 1020 searches for images having the same unique ID of an image generating device from among images stored in the storage unit 1010. The controller 1020 may search for images stored in the storage unit 1010 or images shared in a network. The controller 1020 selects images including time information corresponding to a predetermined time period from among the found images. The predetermined time period can be set by a user or a provider of the image additional information generating apparatus. Thereafter, the controller 1020 sets position information of an image without its position information with position information of an image having its position information among the selected images.

The above-described method of generating additional information of an image can also be embodied as computer-readable codes on a computer-readable recording medium. The computer-readable recording medium is any data storage device that can store data which can be thereafter read by a computer system. Examples of the computer-readable recording medium include read-only memory (ROM), random-access memory (RAM), CD-ROMs, magnetic tapes, floppy disks, optical data storage devices, and so forth. The computer-readable recording medium can also be distributed over network-coupled computer systems so that the computer-readable code is stored and executed in a distributed fashion. Also, functional programs, codes, and code segments for accomplishing the present invention can be easily construed by programmers skilled in the art to which the present invention pertains.

Although the present disclosure has been described with an exemplary embodiment, various changes and modifications may be suggested to one skilled in the art. It is intended that the present disclosure encompass such changes and modifications as fall within the scope of the appended claims.

What is claimed is:

1. A method of generating additional information of an image, the method comprising:
designating a first image;
providing an interface for displaying at least one second image comprising position information; and
setting position information of a selected second image as position information of the first image.

2. The method of claim 1, wherein the first image and the second image comprise time information, and
the providing of the interface comprises providing the interface for displaying the second image if a difference between the time information of the second image and the time information of the first image is equal to or less than a predetermined threshold.

3. The method of claim 2, wherein the time information and the position information are comprised in metadata of the first image and the second image.

4. A method of generating additional information of an image, the method comprising:
specifying at least one object comprised in a first image;
searching for and finding at least one second image comprising the specified object and position information; and
setting the position information of the at least one found second image as position information of the first image.

5. The method of claim 4, wherein the specifying of the at least one object comprises:
if the object is a human being, recognizing a face of at least one human being comprised in the first image; and
specifying the at least one human being according to the recognized face.

6. The method of claim 4, wherein the first image and the second image comprise time information, and
the search for the at least one second image comprises searching for the at least one second image for which a difference between the time information of the at least one second image and the time information of the first image is equal to or less than a predetermined threshold from among the at least one second image comprising the specified object and position information.

7. The method of claim 4, wherein the setting of the position information of the at least one found second image as the position information of the first image comprises:
if the number of found second images is more than one, grouping the found second images; and
setting position information of the group as the position information of the first image.

8. The method of claim 4, wherein the setting of the position information of the at least one found second image as the position information of the first image comprises:
providing an interface for displaying the at least one found second image; and
setting position information of a selected second image as the position information of the first image.

9. A method of generating additional information of an image, the method comprising:
specifying at least one object comprised in a first image and setting a predetermined time period;
searching for at least one second image comprising the specified object, position information, and time information corresponding to the time period; and
setting the position information of the found second image as position information of the first image.

10. A method of generating additional information of an image, the method comprising:
searching for and finding images having the same unique identification of an image generating device, which is comprised in the images;
selecting images comprising time information corresponding to a predetermined time period from among the found images; and
setting position information of images, which do not have position information, with position information of images that have position information among the selected images.

11. An apparatus for generating additional information of an image, the apparatus comprising:
an interface unit configured to designate a first image and display at least one second image comprising position information; and
a controller configured to set position information of a selected second image as position information of the first image based on a user's selection.

12. The apparatus of claim 11, wherein the first image and the second image comprise time information, and
the interface unit displays the second image if a difference between the time information of the second image and the time information of the first image is equal to or less than a predetermined threshold.

13. The apparatus of claim 12, wherein the time information and the position information are comprised in metadata of the first image and the second image.

14. An apparatus for generating additional information of an image, the apparatus comprising:
a storage unit configured to store images; and
a controller configured to specify at least one object comprised in a first image among the stored images, search for and find at least one second image comprising the at least one specified object and position information, and set the position information of the at least one found second image as position information of the first image.

15. The apparatus of claim 14, wherein, if the at least one object is a human being, the controller recognizes a face of at least one human being comprised in the first image and specifies the at least one human being according to the recognized face.

16. The apparatus of claim 14, wherein the first image and the at least one second image comprise time information, and
the controller searches for the at least one second image for which a difference between the time information of the at least one second image and the time information of the first image is equal to or less than a predetermined threshold from among the at least one second image comprising the specified object and position information.

17. The apparatus of claim 14, wherein, if the number of found second images is more than one, the controller groups the found second images, and sets position information of the group as the position information of the first image.

18. The apparatus of claim 14, further comprising an interface unit configured to provide an interface for displaying the at least one found second image,
wherein the controller sets position information of a selected second image as the position information of the first image.

19. An apparatus for generating additional information of an image, the apparatus comprising:
an interface unit configured to specify at least one object comprised in a first image and set a predetermined time period; and
a controller configured to search for and find at least one second image comprising the specified object, position information, and time information corresponding to the time period and set the position information of the at least one found second image as position information of the first image.

20. An apparatus for generating additional information of an image, the apparatus comprising:
a storage unit configured to store images; and
a controller configured to search for and find images having the same unique identification of an image generating device from among the stored images, select images comprising time information corresponding to a predetermined time period from among the found images, and set position information of images, which do not have position information, with position information of images that have position information among the selected images.
